(19) United States
(12) Patent Application Publication
(10) Pub. No.: US 2024/0399513 A1
(43) Pub. Date: Dec. 5, 2024

(54) SIMPLIFIED ROBOTIC WELDING USING TRACED PROFILE, AND ROBOTIC WELDING SYSTEM

(71) Applicant: 649119 N.B. Inc., Miramichi (CA)

(72) Inventor: Robbie Tozer, Miramichi (CA)

(21) Appl. No.: 18/327,818

(22) Filed: Jun. 1, 2023

(30) Foreign Application Priority Data
May 31, 2023 (CA) 3201574

(51) Int. Cl. B23K 37/02; B25J 9/16

(52) U.S. Cl. CPC B23K 37/0229; B25J 9/1666; B25J 9/1684; B25J 9/1694

(57) ABSTRACT

A robotic welding system having detection means for in one embodiment detecting a path of a ferro-magnetic, light-reflective or radioactive material traced over a weld seam, and a controller for providing machine commands to cause a torch tip electrode to move the weld seam. Alternatively the detection means comprises means for detecting and tracking a) a position in 3D space of a pointer tip which is in known positional relationship to determined GPS coordinates of a reference point on the welder when traced along a desired weld seam; b) the path of a point source of light when traced along a location of a desired weld seam; c) the path of light-reflective material traced or positioned over the desired weld seam; or d) a path of a tip of a digitized pointer object when traced along a desired weld seam. Methods of operating such robotic welder also disclosed.

### FIELD OF THE INVENTION

The present invention relates to an apparatus, system, and method for automated welding, and more particularly relates to robotic welding apparatus, system, and method which uses an initial traced profile which is traced along a desired seam of two components to be welded in order to guide the robotic welder for effecting a weld along the traced profile.

### BACKGROUND OF THE INVENTION AND DESCRIPTION OF THE PRIOR ART

According to the American Welding Society, by 2022, the industry will experience a shortage of 450,000 welders.

Use of robotic welding can speed welding processes and save expense, and by speeding welding, can alleviate the shortage of welders and the cost to complete construction projects involving extensive welding.

Conventional welding robots may use online manual programming (or “lead-through” programming), in which an operator uses a hand-held computerized module or pendant to input pre-programmed motions to guide the robot through an entire desired welding motion. The resultant series of pre-programmed steps are recorded to create the robot program for moving the robotic arm and torch tip thereof. This approach requires knowledge of pre-programmed steps and computer programs for controlling the robot arm, and to the extent known, uses a robot which is fixed in place and which has a fixed welding jig affixed thereto in order to consistently position the article in the same orientation and alignment so as to consistently be able to utilize the same repetitive pre-programmed robotic arm motions in the same sequence to carry out the identical same robotic arm motions.

Alternatively, conventional welding robots may use so-called offline programming (OLP) which uses a model of the robot and the robotic welding cell and work piece, to allow a user to generate robot programs using a software package without requiring exclusive access to a physical robot.

Some prior art robotic guidance systems have taken an approach of 3D-digitizing of a part or component so as to be able to recognize the random orientation and position of a component, for a robot to then recognize the location of for example a cavity in an object, for grasping or further handling.

Specifically, 3D sensors such as RGB-D cameras, also called 3D cameras, have been used to obtain a 3D point cloud data of an object, so as to locate apertures therein to be able to grasp same so as to be able to pick an article out of a parts bin, for example, in a desired orientation, for subsequent welding or treatment in regards to such component.

For example CA 3,061,021 to ABB Schweiz AG entitled “Robotic Systems and Methods for Operating a Robot” teaches use of 3D cameras to obtain 3D point cloud data of the structure; analyzing the 3D point cloud data at a lower dimensionality to eliminate irregularities; performing boundary detection of the 3D point cloud data at the lower dimensionality; and performing a multi-cavity detection of the 3D point cloud data to detect cavities in the structure for subsequent handling by a robot.

To similar effect, US Pub. 2021/0069813 entitled “Systems and Methods for Seam Tracking in Pipe Welding” teaches a method comprising rotating pipe sections so a 3D camera may determine the seam position, moving a torch arm and welding torch so that the torch is over one of the plurality of stitches, adjusting welding parameters and determining stitch start when welding torch is over a stitch and further adjusting welding parameters and determining stitch end when welding torch moves past one of the plurality of stitches.

Still to further effect US Pub. 2019/0160583 to “Methods and Systems using a Smart Torch with Positional Tracking in Robotic Welding” teaches an electric arc welder torch with sensors to determine the absolute position of the torch tip and the relative position of the torch tip to the weld joint during automatic welding.

Still further, US Pub. 2017/0368632 to a “Machine Vision Robotic Stud Welder” teaches an apparatus for automatically welding studs on a surface of a beam at pre-marked welding sites located on the surface of the beam, the beam having a longitudinal axis, the apparatus comprising a carriage that is operably configured to be movable parallel to the longitudinal axis of the beam; at least one imager connected to the carriage, the imager being operably configured to capture a plurality of images of the surface of the beam as the carriage is being moved; at least one welding assembly attached to the carriage, the at least one welding assembly being in data communication with the computer and being movable relative to the location of the carriage; and a computer in data communication with the at least one imager and the at least one welding assembly, the computer being operably configured to identify at least one pre-marked welding site that is located on the surface of the beam in one or more of the plurality of images and to determine the location of the at least one pre-marked welding site relative to the location of the carriage and relative to the location of the at least one welding assembly; wherein the computer is operably configured to command the at least one welding assembly to automatically place and weld a stud to the surface of the beam at the at least one pre-marked welding site.

Improvements to such prior art, including simplification of operation and reduction or elimination of otherwise necessary programming of movement, and better systems to free up human oversight in the welding process are nonetheless are still needed.

Moreover, prior art robotic welding machines are often located at a fixed-position welding stations, with fixed welding jigs or welding fixtures. They are thus not configured so as to be adapted to adjust to different welding sites and locations which may be designated by a welder and which may exist at various locations around a construction site.

Accordingly, further improvements are needed in the welding industry to allow ease of relocation of welding robots to different locations around a construction site, without sacrificing the speed and automation of welding of articles.

For example, in rebar-reinforced concrete structures such as in concrete bases for wind towers which have need of a re-bar mesh to re-enforce such concrete bases, extensive numbers of welds are needed to weld lengths of weldable re-bar (ie meeting spec AWS D1.4M: 2011 for weldable re-bar) together to create a supporting shell or frame for the concrete-supporting structure.

Automation of needed repetitive welding of re-bar lengths at various locations over a construction site such as at a concrete base for a wind tower, via a transportable robot welding device and at locations as specifically designated by a welder, is but one example where improvements in robot welding technology would assist in the reducing labour costs and expense of creation of such structures.

As regards obstacle avoidance mechanisms, a number of technologies exist for excavators using visual guidance systems to allow operators of excavators and cranes to be warned of and avoid obstacles such as overhead power lines, adjacent buildings, and the like.

For example, US 2022/0067403 entitled “Visual Guidance System and Method” teaches a visual guidance system for vehicles using an imaging system for producing a digital image of an environment, a 3D scanning system for producing a digital point cloud of the environment, and a memory storing instructions executable by a processor to: (i) process the digital image to detect an object and classify the object; (ii) process the point cloud to group points into a grouping representing the object; and (ii) report a threat if the threat of encountering an obstacle or obstruction exceeds a threshold.

It would be of benefit if a portable robotic welder could be provided with obstacle avoidance technology that automatically prevents interference with an obstacle during the welding process, and recalculates an alternative means of moving its robotic arms to generate a path of movement of a torch electrode tip thereon that does not result in the torch tip or any robotic arms coming into contact with the potential obstacle.

### SUMMARY OF THE INVENTION AND SOME OF ITS EMBODIMENTS

It is an object of the present invention to co-opt the use of an initial manual tracing of a desired weld seam on one or more articles, in conjunction and in association with a robotic or automated welding apparatus, to not only simplify but to also further speed up and/or economize in the time and money incurred in effecting robotic welding on the one or more discretely-located articles on a shop floor or at a construction site,

It is a further advantage and object of the present invention to provide a system and method that it is able to effect robotic welding of weld seams on articles or objects which may be positioned in different relative geometric orientations and at different locations on a shop floor or welding location, and eliminate the need to transport an article to a robotic welder and position the article as such specific welding location in a consistent orientation and position before robotic or automated welding can be carried out.

It is a further object and advantage of the present invention to provide a system and method which in at least one embodiment thereof allows reduction of the number of complex and expensive hardware components and/or complicated programing of the path of a robotic welder along a desired a weld seam which elaborate programming has typically been needed to be carried out by sophisticated programmers in prior art robotic welders and prior art robotic welding techniques.

It is a further object of the present invention in various embodiments thereof to provide a robotic welding system which avoids having to effectively use AI tools to “recognize” orientation of components.

It is a further object of the present invention in various embodiments is moveable, such as being mounted on a variably positionable overhead gantry or on a vehicle, and thereby eliminate need for fixed-position welding fixtures which restrict transportability of a robotic welder from position to position within a construction site or with a shop facility.

It is a further object of the present invention in various embodiments to provide a robotic welding system which may be easily transported, to various locations of articles to be welded, or is variably positionable by virtue of being mounted on an overhead gantry which is positionable in 2 or 3 dimensions along a shop floor.

It is a still-further object of the robotic welding system of the present invention, to be able to avoid potential obstructions when operating the robotic arm and welding torch of such robotic welder.

Accordingly, in a first broad and simplest aspect the present invention comprises a robotic automated welding system which can quickly and with less complex hardware and software and easier transportability than many existing robotic welding systems, create automated welding. More particularly, in such first broad and simplest aspect, a robotic welding system is provided, comprising:
(i) a robotic welder, having a torch tip electrode for providing an electric current and which torch tip electrode is variably positionable and moveable in three or more degrees of freedom;
(ii) detecting means:
   (a) for detecting a path of a previously-created manual tracing of a ferro-magnetic, light-reflective, or low grade radioactive material which is traced over or placed on a location of said desired weld seam in relation to one or more articles on which welding is required along said desired well seam thereon;
(iii) a controller for providing necessary machine commands to said robotic welder to cause said robotic welder to commence welding at one end of said manual tracing and to progressively move said torch tip electrode along a length of said detected manual tracing to effect welding along said desired weld seam.

In such manner, by using detectable amounts of ferro-magnetic, light-relective, or low grade radioactive material, the traced profile is detectable and thus already located in 3D space, and which allows a robotic welder to then detect the exact presence of the weld seam and thereafter conduct the welding along a desired weld line. Such apparatus may thereafter be transported or repositioned to effect welding along said manual tracing on a second or more articles which have a traced profile similarly provided thereon

Similarly, the present invention comprises in a similar broad aspect a method of welding for using a robotic welding system as described above, comprising the steps of:
i) positioning a portable robotic welder in proximity to two members to be welded together along a weld seam;
(ii) detecting a path of a tracing of a ferro-magnetic, light reflective, or low-grade radioactive material which is traced over or placed on a location of said desired weld seam, and creating a series of datapoints in respect of the detected location in 3D space of said traced path; and
(iii) using a controller to provide said necessary machine commands to said robotic welder to cause said robotic welder to move a torch tip electrode thereon progressively along a length of said traced path to effect welding of said two members together along said traced path.

Such method may further including a step prior to step (iii) of creating a series of datapoints in respect of a 3D spatial location of said path relative to a location of a reference datum point of the robotic welder.

In a further refinement, the method may further comprise the steps of moving a flexible tracing tool, having a known physical relationship to a reference datum point on said robotic welder, over and along said traced path and recording or storing the relative (as opposed to purely Euclidian) spatial 3D position of said tracing tool as it is moved along said traced path; and thereafter using the controller to provide said necessary machine commands to the robotic welder to cause the robotic welder to move the torch tip electrode thereof progressively along the length of the tracing path and at the same time effect welding along the desired weld seam.

In a further refinement of this particular method, the torch tip electrode of the robotic welder, when in a non-energized and non-welding state, comprises the flexible tracing tool which is initially moved over and along the desired weld seam to create the series of datapoints which designate the position in 3D space of the weld seam relative to a reference datum point, such as a datum point on a stationary point on the robotic welder.

In a preferred embodiment, the robotic welding system may be transportable, such as by mounting on an overhead moveable gantry which is moveable in 2 or more dimensions within a shop facility, or by mounting on a vehicle for transportation to various locations or articles or objects situated at a construction site.

In a further preferred embodiment, particularly where the robotic welding system is transportable, obstruction detection means which detect 3D spatial location of any possible obstruction if the machine commands generated by said controller would cause a robotic arm or arms of said robotic welding system or portions thereof to contact and thus be constrained in their movement and which would otherwise cause said torch electrode tip to be unable to follow such traced path. In the event a possible obstruction is indicated, said controller generates alternative machine commands to cause said robotic arm or arms to avoid contact with said obstruction and so as to permit said torch electrode tip to follow said traced path.

Such obstruction detection means may be comprised of laser light emitting devices, or more preferable, sonar detection devices to warn of obstacles in proximity, such as typically found in modern automobiles.

The robotic welding system and method of the present invention, in contrast to prior art systems and methods, takes advantage of and “co-opts” a human operator to initially create a tracing or traced path along a weld seam of a pair of components to be welded together, which may be detected by the robotic welder in various manners described herein, depending on the type of tracing or traced path. The robotic welder can then make use of such detected traced path to “track” and then provide automated welding along the weld seam.

While ferro-magnetic or low grade radioactive tracing may be simultaneously detected and used to guide a robotic tool to immediately conduct the desired welding along a weld seam, use of a light reflective material or ink which can be detected by light receptive sensor or ccd (charge coupled device) on a welding apparatus, due to the high intensity light that is emitted during welding, may in some instances unworkable as any light detection means for detecting such a tracing profile is effectively “blinded” by light emitted during the welding process itself.

Accordingly, where neither ferro-magnetic material or low grade radioactive materials are used as the tracing or marking material and instead detection of light reflected from a light-reflective ink or paint is desired to be used as the means of determining the spatial location in 3D space of the weld tracing, an initial tracing step and additional refinements may needed in order allow a robotic welder to initially “read” where the tracing profile is located so as to not be “blinded” by the high intensity light being emitted from the torch welding rod during welding, store the detected traced profile in memory, and thereafter then knowing of the relative 3D special location of the desired weld seam, then conduct the desired welding along such weld seam.

Accordingly, in another broad aspect of the present invention which again “co-opts” use of a manual-created tracing or traced path of the desired weld along a weld seam, automated welding of components at various locations of a construction site can alternatively be carried out.

Accordingly, in an alternative broad aspect, the present invention provides a robotic welding system which is capable of firstly detecting a manually-traced profile on a weld seam, and thereafter creating and storing in memory the determined 3D special co-ordinates (relative to a stationary known reference point on the robotic welder) of a manually-traced profile along a weld seam to be welded. The robotic welder thereafter proceeds to use such created relative 3D spatial coordinates to subsequently guide a torch tip electrode along the weld seam to weld the article along the location of the traced profile.

In this embodiment the tracing profile is determined in 3D space in relation to a reference point and/or a known datum point on the robotic welder. As regards such further refinement, the tracing profile (from which the 3D spatial coordinates thereof may then be determined and initially created one of the following alternative manners:
(a) by simply tracing a pointer tip, such as a torch tip electrode of a robotic welder whose 3D coordinates are at all times known in relation to a reference point and in relation to fixed location on the robotic welder), along a location of a desired weld seam of two members desired to be welded together;
(b) by detecting a path of a point source of light, when such point source of light is traced along a location of a desired weld seam of two members desired to be welded together;
(c) by a path of a light-reflective paint, ink, or a light-reflective material, which is traced over or placed on or adhered to a location of said desired weld seam; or
(d) by pointer object having a tip which has been digitally imaged so as to be machine recognizable, and tracing such pointer object along a desired weld seam of two members desired to be welded together.

Accordingly, in this aspect of present invention there is provided a robotic welding system comprising:
(i) a robotic welder, having a torch tip electrode for providing an electric current and which torch tip electrode is variably positionable and moveable in three or more degrees of freedom;
(ii) detecting and tracking means:
   (a) for detecting the GPS co-ordinates of a reference point on said robotic welder when stationary, and tracking a position in 3D space of a pointer tip which is in constant known positional relationship to said reference point when said pointer tip is traced along a location of a desired weld seam of two members desired to be welded together, and creating a series of datapoints in respect of said traced path; or
   (b) for detecting and tracking position in 3D space relative to a reference point in which is in known positional relationship to said robotic welder, a path of a point source of light when traced along a location of a desired weld seam of two members desired to be welded together, and creating a series of datapoints in respect of said traced path; or
   (c) for detecting and tracking in 3D space relative to a reference point which is in known positional relationship to said torch tip electrode, a path of a tracing of a light-reflective paint, ink, or a light-reflective material, which is traced over or placed on or adhered to a location of said desired weld seam, and creating a series of datapoints in respect of said traced path; or
   (d) for digitizing a pointer object having a tip, and detecting and tracking a path of said tip of said digitized pointer object, in 3D space relative to a reference point in relation to said robotic welder, when said tip of said pointer object is traced along a desired weld seam of two members desired to be welded together, and creating a series of datapoints in respect of said traced path;
(iii) data storage means for permitting storing of said datapoints in a memory; and
(iv) a controller for accessing said data storage means and said memory and utilizing said datapoints so as to calculate and provide necessary machine commands to said robotic welder to cause said robotic welder to move said torch tip electrode thereof progressively along a length of either of said traced paths (a), (b), (c), or (d) to effect welding of said two members together along one of said traced paths (a), (b), (c), or (d).

In above alternative configuration (ii) (a) where GPS 3D spatial co-ordinates of the tracing profile are generated from the known relationship of the pointer tip to a non-movable reference point on the robotic welder having known 3D spatial co coordinates there is no need to make any additional measurements to determine the 3D special co-ordingates.

However, in embodiments where for example a light-reflective paint, ink, or material is used for the tracing profile and no pointer tip with known relation to the reference point on the robotic welder is used, it is thus necessary to measure the distance from a known temporarily fixed-in-space reference point on the robotic welder to a series of points on the traced profile, in order to be able to instruct the robotic welder of the precise manner to move and locate the torch tip.

This can be done by means of known LIDAR (Light Detection And Ranging)) techniques for determining distances and triangulation techniques to determine relative 3D position in space.

For example, by using three spatially-separate sensors on a robotic welder to provide separate distances to a single point source of light on a tracing path, or by moving a single sensor to at least three separate distinct known locations, and by then using triangulation with regard to such three located distances from a known fixed point on the robotic welder, the precise location in 3D space of such single point source of light on the traced path can be determined.

Such process is then repeated or continued for a series of illuminated points along the tracing path (which may be points of reflected light along the tracing path), so as to provide a 3D spatial orientation of the traced path with respect to location the fixed reference point on the robotic welder.

Alternatively, three spatially-separate sensors, or a single sensor situated in three separate locations, may be used to each provide distances to a series of points along the entire length of the tracing path as measured by the sensor(s), and then by using triangulation methods for determining the separate distances from each of the sensors to corresponding point(s) along the traced path, may be used to then to determine the precise location in 3D space of all of such points on the traced path.

Accordingly, to allow the robotic welder and system of the present invention to operate in the above manner the detection and tracking means in subparagraph (ii) (b) (c), or (d) above need further comprises:
a camera or charge coupled device (CCD) to detect light reflected from said traced path or pointer tip,
a laser light source and means for directing said laser light source along said detected traced path; and
means for determining distance of each of said numerous points on said traced path from said reference point using said laser light source and light detection and ranging (LIDAR).

In preferred embodiments, the robotic welding system is portable and may be moved and stationed at various locations at a construction site and to various components in need of welding.

In a refinement, each robotic welder may be provided with stabilization means, which in one embodiment may comprise a tripod base having three extending legs for stabilizing the robotic welder at each of various points around a construction site.

In an alternative embodiment, the stabilization means may be a vehicle or truck, which provides stabilization when the vehicle is positioned at a location for welding of articles.

For example, the robotic welder and robot arms thereof may be positioned on truck or other mobile vehicle to allow its transportation to various locations in a construction site, with the robotic arm having the torch tip electrode effectively comprising a boom or gantry arm to allow the robotic arm of the robotic welder to extend outwardly from the truck and to extend into an area, such as within a rebar mesh created for a concrete base for a wind tower, to weld intersecting portions of re-bar mesh which are needed to create a solid and inflexible mesh for concrete to be poured into such re-bar mesh for forming a concrete wind tower base.

In either embodiment the stabilization means for the mounting of robotic welder thereon, whether a mobile truck with additional arm stabilizers thereon, or a tripod base extending from grade and forming a base of the robotic welder, stabilizes the robotic welder so that in the embodiment where, such as in subparagraph (ii) (a) above, the GPS co-ordinates of the reference point are needed to be obtained so as to thereafter be able using known geometric relation between a pointer tip and the reference point to determine the 3D spatial coordinates of the traced path for welding, such GPS coordinates of the reference point can be quickly and accurately obtained due to the stability of the robotic welder.

Operator input may sometimes be needed to make additional custom adjustments to the robotic welder with respect to, for example, adjusting the number of weld passes needed to generate a weld bead of sufficient size, which may vary from component to component being welded, or to adjust other parameter which may affect as the desired width, depth, and size of a weld bead where a welding such as arc welding of components is desired.

Accordingly, in a preferred embodiment, the robotic welding system of the present invention further possesses a sensor means for sensing a height or depth of a weld bead created by torch tip electrode being progressively moved along a traced path of a weld seam, and real-time adjustment means for controlling, in real time, one or more of:
(i) a speed of travel of said torch tip electrode along said path; or
(ii) an amount of amperage of electrical current applied to said torch tip electrode.

In a further preferred embodiment of the invention, similarly for the purposes of allowing the robotic operator the ability to adjust the aforesaid weld parameters in real time and “on the fly”, the robotic welding system may further comprise operator input means to allow an operator to set and/or adjust, in real time, a position of a weld bead being created by adjusting the created 3D profile and thus the movement and positioning of the torch tip electrode on the robotic arm along the traced or determined path (weld seam).

Importantly, when moving a robotic welder to various locations at a construction site, various and differently-located obstacles may be present, which might, in certain rotational and directional movements of a robotic arm, potentially obstruct the arm and prevent such robotic arm and the torch electrode tip thereon from following, or completely following the traced or determined weld seam desired to be welded.

For example, in construction of re-bar meshes used in the construction of wind turbine tower bases, in some instances adjoining rebar mesh may hinder or partially obstruct access to another weld seam desired to be welded between proximate re-bar components.

Accordingly, it is thus highly desired and preferable, including from a safety point of view, that a robotic welder in providing machine instruction to the robotic arm thereof to cause the torch electrode to trace and move along the 3D path thereof, particularly in the case of a portable robotic welder, be capable of determining a series of rotational and translating movement of such robotic arm thereof so as to cause the torch tip electrode to be moved along the traced profile or weld seam without interference or obstruction by other already-welded rebar or other obstacles, including persons.

Accordingly, in a highly desirable aspect of the present invention, particularly in the case of a portable robotic welding system, a robotic welding system is provided, further having obstruction detection means which detects 3D spatial location of a possible obstruction of a robotic arm on the robotic welder if the machine commands generated by the controller of the robotic welder would cause a robotic arm or arms of said robotic welding system or portions thereof to contact and thus be constrained in their movement and which would otherwise cause said torch electrode tip to be unable to follow such traced path, and in the event a possible obstruction, the controller generates alternative machine commands to cause said robotic arm or arms to avoid contact with said obstruction and so as to permit the torch electrode tip to then be able to follow the traced path without obstruction.

Thus at a construction site where persons and transitory or non-transitory obstacles may appear which may, in some selections of machine commands to control the robot arms and gantry of such robotic welder, potentially obstruct the intended path of movement of the moment arm, a method for operating a robot welder is provided. Such method comprises the steps of:
detecting any possible obstruction if the machine commands generated by said controller would cause a robotic arm or arms of said robotic welding system to contact and thus be constrained in their movement and thereby cause said torch electrode tip to otherwise be unable to follow such traced path; and
in the event a possible obstruction is indicated, causing said controller to generate alternative machine commands to cause said robotic arm or arms to avoid contact with said obstruction.

In a further broad aspect of the invention where 3D spatial co-ordinates of the traced path are generated, a method for operating a robotic welding apparatus is provided.

Such method in accordance in one aspect thereof comprises the steps of:
(i) positioning said robotic welding apparatus in proximity to two members to be welded together along a weld seam;
(ii) carrying out the step of either:
   (a) detecting the GPS co-ordinates of a reference point on said robotic welder, and tracking a position in 3D space of a pointer tip which is in known positional relationship to said reference point, when said pointer tip is traced along or in close proximity to, a location of a desired weld seam of two members desired to be welded together, and creating a series of datapoints in respect of said traced path; or
   (b) detecting and tracking in 3D space relative to a reference point in which is in known positional relationship to said robotic welder, a path of a point source of light when traced along or in close proximity to, a location of a desired weld seam of two members desired to be welded together, and creating a series of datapoints in respect of said traced path; or
   (c) detecting and tracking in 3D space relative to a reference point which is in known positional relationship to said robotic welder, a path of a tracing of a light-reflective paint, ink, or a light-reflective material, which is traced over or placed on a location of said desired weld seam, and creating a series of datapoints in respect of said traced path; or
   (d) digitizing a pointer object having a tip, and detecting and tracking a path of said tip of said digitized pointer object, in 3D space relative to a reference point in relation to said robotic welder, when said tip of said pointer object is traced along or in close proximity to a location of a desired weld seam of two members desired to be welded together, and creating a series of 3D referenced datapoints in respect of said traced path;
(iii) storing said datapoints in a memory; and
(iv) accessing said memory and utilizing said datapoints to calculate necessary machine commands to cause said robotic welder to move a torch tip electrode thereon progressively along a length of one of said traced paths (a), (b), (c), or (d) to effect welding of said two members together along one of said traced paths (a), (b), (c), or (d); and
(vii) using a controller to provide said necessary machine commands to said robotic welder to cause said robotic welder to move a torch tip electrode thereon progressively along a length of said traced path to effect welding of said two members together along said traced paths ne of said traced paths (a), (b), (c), or (d) to effect welding of said two members together along one of said traced paths (a), (b), (c), or (d).

As a refinement of each of the alternate steps (b), (c) or (d), the step therein of detecting and tracking in 3D space comprises utilizing at least three detecting and tracking means which track the traced path of either step (b), (c), or (d) by each simultaneously measuring or determining distances of numerous points in said traced path in (b), (c), or (d) from the reference point; and thereafter or simultaneously-utilizing triangulation of each of the numerous measured points obtained from each of said at least three detecting and tracking means to determine the location in 3D space of said numerous points on said traced path.

### BRIEF DESCRIPTION OF THE DRAWINGS

Further advantages and permutations and combinations of the invention will now appear from the above and from the following detailed description of various particular embodiments of the invention, taken together with the accompanying drawings each of which are intended to be non-limiting, in which:

FIG. 1 shows a perspective schematic view of one embodiment of certain components of the robotic welding apparatus of the present invention, showing use of such robotic apparatus in welding according to one of the embodiments of the method of the present invention;

FIG. 2A shows a perspective schematic view of another embodiment of certain components of the robotic welding apparatus of the present invention, showing use of such robotic welding system in welding according to another of the embodiments of the method of the present invention, in a first datapoint generation step thereof;

FIG. 2B shows a perspective schematic view of another embodiment of certain components of the robotic welding apparatus of the present invention, showing use of such robotic welding system in welding according to another of the embodiments of the method of the present invention, in a second welding step thereof;

FIG. 3A shows a perspective schematic view of an embodiment of certain components of the robotic welding apparatus of the present invention, showing use of such robotic welding apparatus components in welding in a first step of a method of robotic welding of the present invention;

FIG. 3B shows a perspective schematic view of certain components of the embodiment of the robotic welding apparatus of FIG. 3A, as employed in carrying out a second step of a method of robotic welding of the present invention;

FIG. 4 shows a perspective schematic view of an embodiment of the robotic welding apparatus, wherein such robotic welding apparatus is transportable and in the embodiment shown, is truck-mounted;

FIG. 5 is a schematic flow diagram showing one broad embodiment of a method of carrying out automated welding using a robotic welding system using the present invention;

FIG. 6A is a further schematic flow diagram showing another broad embodiment of a method of carrying out automated welding using a robotic welding system using the present invention;

FIG. 6B is a schematic flow diagram of a more detailed view of an optional aspect of the method of the invention shown in FIG. 6A;

FIG. 6C is a schematic flow diagram of a further alternative or optional aspect of the method of the invention shown in FIG. 6A;

FIG. 7 is a perspective schematic view of certain components of the embodiment of the robotic welding apparatus of FIG. 3B, further having an improvement of means to detect the height or depth of a created weld bead, and adjustment means to vary the speed of the torch tip electrode moving along a weld seam and/or the amount of electric current provided to the torch tip electrode; and

FIG. 8 is a perspective schematic view of a further refinement of the embodiment of the robotic welding apparatus shown in FIG. 4.

### DETAILED DESCRIPTION OF SOME PREFERRED EMBODIMENTS

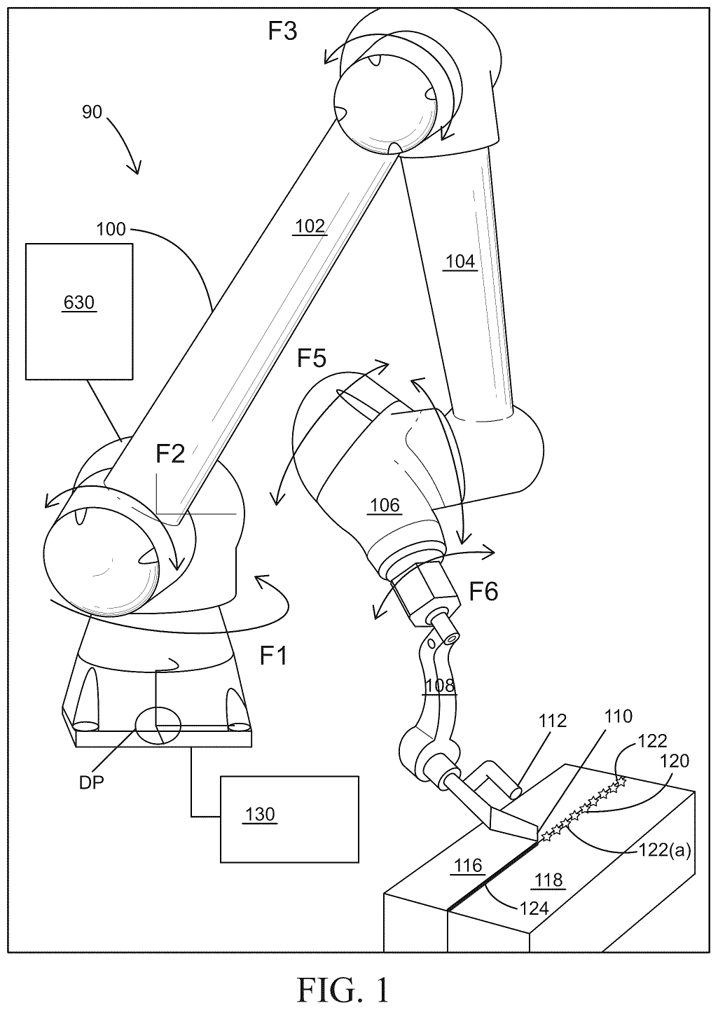

FIGS. 1, 2A, 2B, 3A, 3B, 4, 7 & 8 show embodiments of robotic or automated welding system 90 of the present invention, adapted to weld two components 116, 118 together along a desired weld seam 120, using one or more of the systems and methods of the present invention.

A robotic or automated welder 100 is provided which comprises: a plurality of moveable robot arms 102, 104, 106, and 108; a torch tip electrode 110; and a controller unit 130 which may receive input from sensor(s) 112, and for controlling servo-motors (not shown) which regulate the position of robot arms 102, 104, 106, and 108 and thus the position of torch tip electrode 110.

Torch tip electrode 110, located at the distal end of robot arm 108, is variably positionable and moveable in three or more degrees of freedom, to accommodate welding of variously-positioned weld seams 120 of various geometries.

In the embodiments shown in FIGS. 1, 2A, 2B, 3A, 3B, 4, 7, & 8 torch tip electrode 110 located at distal end of robot arm 108 is moveable in six degrees of freedom, as designated by arrows F1, F2, F3, F4, F5 and F6 shown in FIGS. 1, 2A, 2B, 3A, 3B, 4, 7 & 8 herein.

In a preferred embodiment, the robotic welding system 90, 95 is transportable in order to be able to quick and easy relocation of a self-contained welding system to various locations about a construction site (not shown), where automated welding of components, such as welding of numerous sets of re-bar junctions in a rebar mesh for a poured concrete base for a wind turbine, may be located.

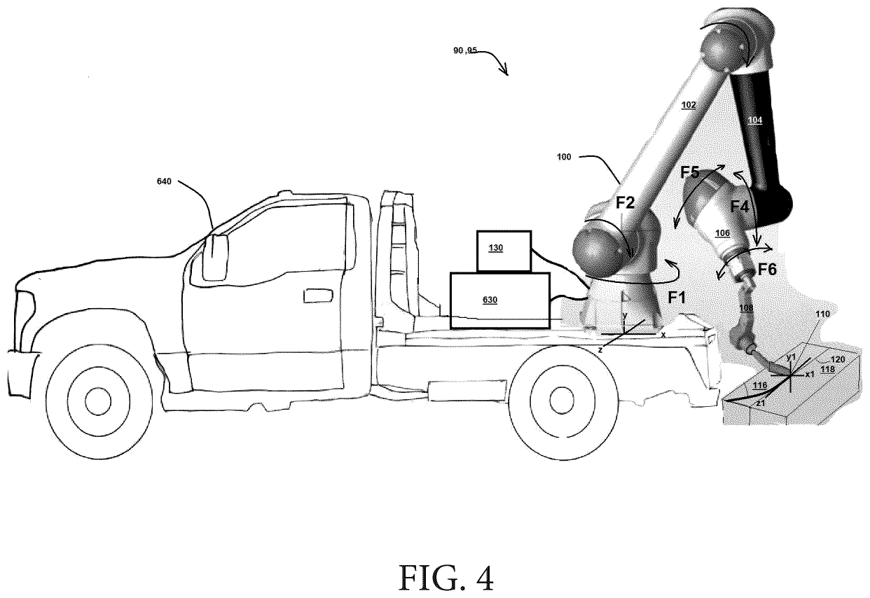

FIG. 4 shows an exemplary embodiment where the robotic welding system 100 of the present invention is transportable and mounted on the rear of a vehicle or truck 640. Vehicle 640 preferably further possess an self-contained electrical power generation unit 630 for the purpose of providing both electrical current for welding and further providing an additional source of electrical power for a controller 130 which operates the servo-motors (not shown), which servo-motors then control and move each of the robotic arms 102, 104, 106, and 108. In such manner a portable and self-contained robotic welding system 90 can be provided at various locations at a construction site, and even in locations which may not have access to a source of electrical power.

FIG. 1 shows a robotic welding system 90 of one aspect of the invention, where proximate to the torch electrode tip 110 and mounted on the distal end of robotic arm 108 there is provided detecting means 112 in the form of one or more or sensors 112 for detecting in relative 3D space a traced path 122 of a ferro-magnetic, light reflective, or low grade radioactive material 122a which is traced over, adhered to, or placed on or along a location of said desired weld seam 120 in relation to two articles 116, 118 to be welded together.

Specifically, detecting means 112 may be a single sensor in known spatial relation to a fixed datum point DP on the robotic welder 100, which is moved to at least three separate spatial locations and positions known in relation to a datum point on the welder, to respectively sense at each of such at least three separate spatial locations distance to a series of points along a traced path 122 in order to triangulate the position in 3D space of such series of sensed points along the traced path 122.

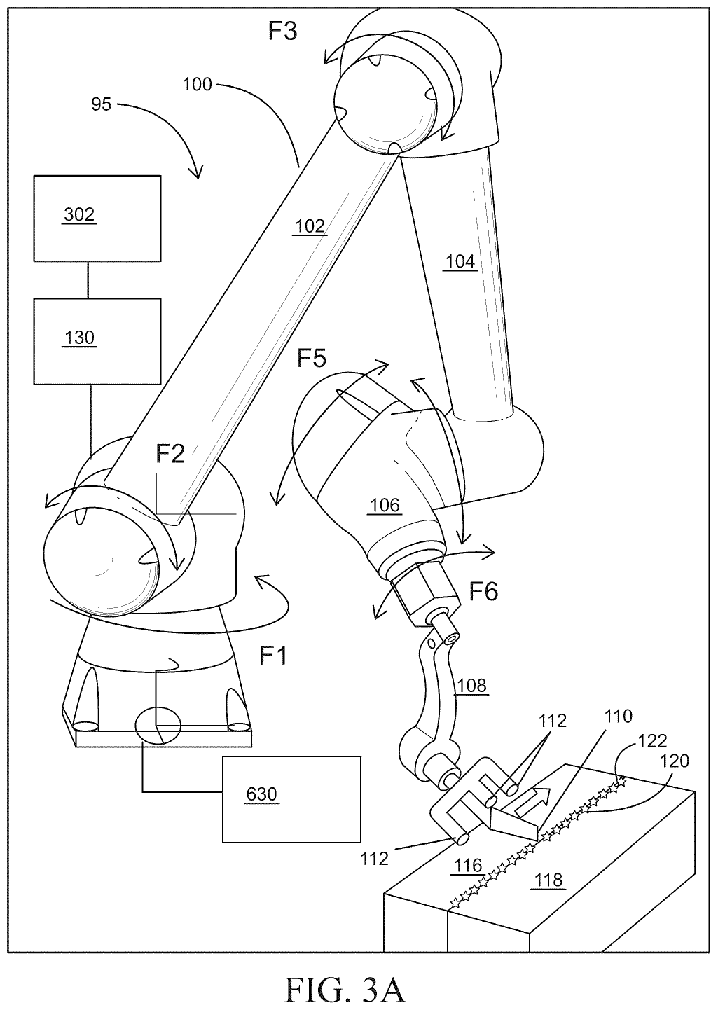

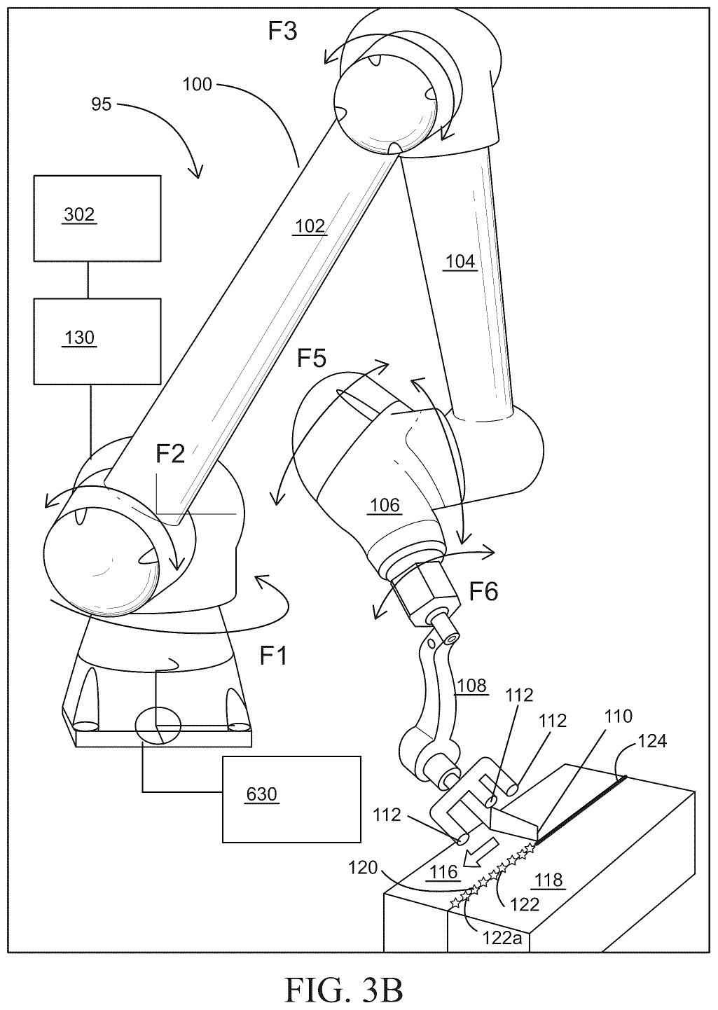

In an alternative embodiment, detecting means 112 may comprise a series of three sensors or more sensors 112 spatially separated from each other as shown in FIGS. 3A & 3B in a known spatial relation to a fixed datum point “DP” on the robotic welder 100, in order that distances or signal strengths and azimuth direction as simultaneously sensed by each of such three sensors 112 emanating from the traced path 122 may be tracked and used in a manner of triangulation to determine the location in 3D space of the traced path and in relation to the torch tip electrode which is in known relation to the datum point DP.

In another embodiment, a combination of each of the above aforementioned two methods may be used to triangulate and thereby determine the relative 3D spatial location of a series of points along the traced path 122 along the desired weld seam 120 relative to a fixed datum point, which then allows the robotic welder 100, knowing of the position of each of the sensors relative to the torch tip electrode for any orientation thereof, to then cause the torch tip electrode 110 to be able to move along traced path 122.

Where a ferro-magnetic material 122a such as magnetized iron filings or a similar ferro-metallic compositions or powders are used as the tracing material 122 (a) for placing on a weld seam 120 of two ferrous metal components 116, 118 desired to be welded together, such ferro-magnetic material, being ferrous and of the same or similar composition of the materials being welded, advantageously would not detrimentally contaminate the surface of the weld seam 120 by introduction of detrimental impurities in the to-be-created weld bead 124 and thus have no detrimental effect on the to-be-created weld bead 124. Moreover, a ferro-magnetic material 122a has the advantage of adhering to either sides of a weld seam 122 of articles 116,118 desired to be welded, as such articles 116,118 will typically likewise be of a ferrous metallic composition and to which such ferro-magnetic material 122a may thus easily adhere to. Many types of suitable and non-contaminating ferro-magnetic materials will, depending on the metallic composition of the two articles 116, 118, now occur to welders and persons of skill in the art. Obviously, ferro-magnetic materials which contain undesirable impurities or which would introduce unsuitable compounds into the created weld bead and which would weaken the integrity of the weld would be unsuitable for such use and would be known to persons of skill in the art to be avoided.

Where a ferro-magnetic material 122a such as magnetized iron filings or a similar ferro-metallic composition is used as the tracing material 122a, sensor(s) 112 may comprise magnetic field sensors. Such magnetic sensor or sensors 112 may be used to sense the position, length, and azimuth direction of a magnetic field created by the ferro-magnetic material placed over and along the desired weld seam 120. Datapoints from such sensor defining the detected position, length, and azimuth direction of the traced path 122 along desired weld scam 120 and thus the relative position in 3D space of such traced path 122 relative to the datum point DP and thus relative to the torch tip electrode 110 of robotic welder 100, can thus be determined for the purposes of allowing a controller 110 of the robotic welder 100 to thereafter determine the necessary machine commands to direct the torch tip electrode 110 on robotic welder 100 to weld along the weld seam 120 to create a desired weld bead 124.

Alternatively, where a low-grade radioactive material is used as the tracing material, such may comprise a ferrous material similar in composition to that of the components 116, 118 being welded, but which has further been made to have low-grade radiation emitting qualities. In such manner, due to having the identical or similar metallic composition and properties as the components being welded the tracing material 122a is not going to otherwise introduce any undesirable impurities or undesirable metallic substances which could compromise or detrimentally affect the welding of the two materials 116,118.

Sensors 112 capable of detecting strength, frequency, and direction of emitted radiation for a traced path 122 comprising such low grade radiation-emitting material may similarly be used, similar to light detecting sensors 112 or magnetic field detecting sensors, and in the manner as indicated above, in order to locate in relative 3D space to a known datum point DP on the robotic welder 100 which is in known mechanical relation to the position of the torch electrode tip 110, in order for a controller 130 to receiving input from said radiation-detecting sensor(s) 112 detecting means and providing necessary machine commands to said robotic welder 100 to cause robotic welder 100 to commence welding at one end of the detected manual traced path 122 and to progressively move torch tip electrode 110 along a length of traced path 122 so as to thereby effect welding together of two articles 116, 118 along desired weld seam 120.

In the event that a light-reflective material 122a is used as the means for tracing a light-reflective path 122 along a desired weld seam 120, such light reflective material 122a may any suitable light-reflecting material which reflects light of a frequency which one or more detecting sensors 112 may be sensitive or detect.

In a preferred embodiment where a light-reflective material 122a is used as the means for tracing a light-reflective path 122, a source of light such as a source of laser light (not shown) may further be provided, situated on a mutual longitudinal axis on which the light detecting sensor(s) are located and used to detect light reflecting from the light-reflective material. The source of light emits light in a direction away from a sensor 112 in such a manner that if such light falls on a point on the light reflective material on the traced path 122, the reflected light will be directly reflected back to such sensor, thereby assisting such sensor 112 in locating and determining a directional location and position of point of reflected light on the traced path 122.

As noted in the Summary of the Invention, for reasons such as “blinding” of light detecting sensors 112 if welding was to be attempted to be conducted simultaneously in real time with the continued detection of the traced path, in an alternative embodiment, in order to use light sensors 112, or as an alternative embodiment, a traced path may first be located and determined datapoints then stored in memory. Thereafter, when welding is then desired, such memory and stored datapoints are then accessed by a controller 130 to thereafter direct the torch electrode tip 110 along the calculated and pre-detected/pre-determined path 122.

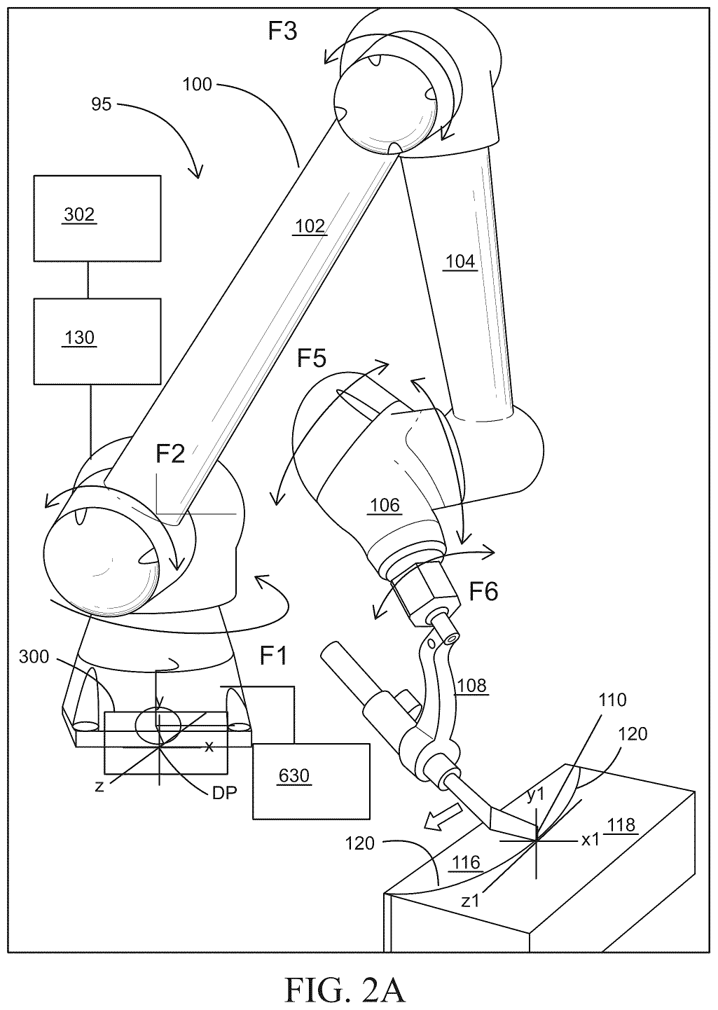

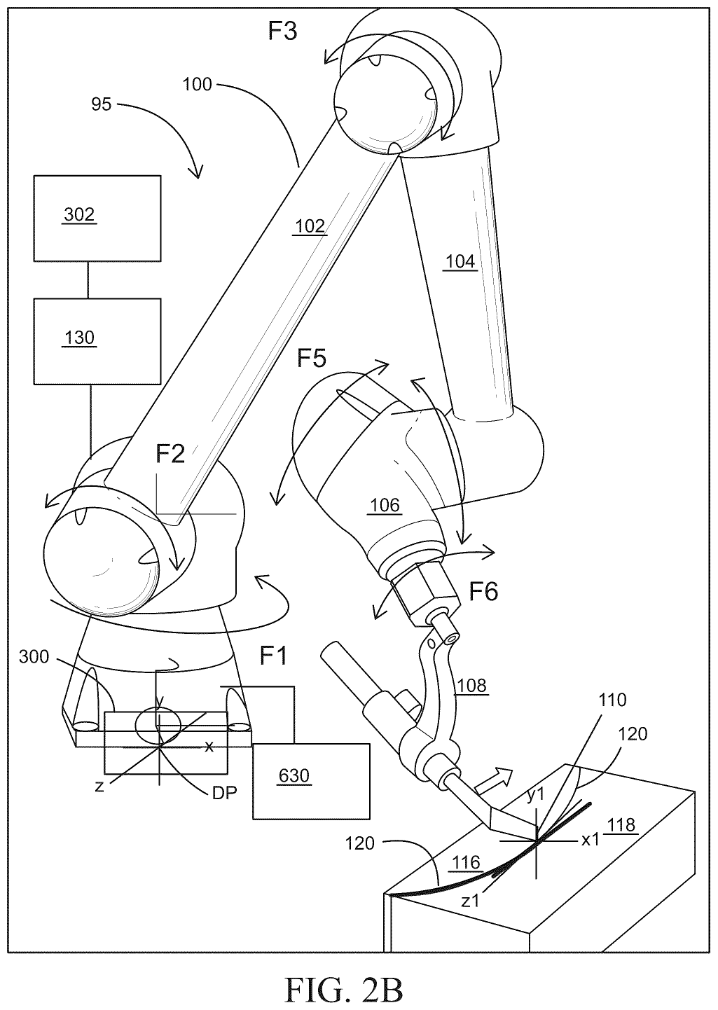

Various embodiments of such an alternative robotic welding system 95 are shown for example in FIGS. 2A&2B and FIGS. 3A &3B.

In a first embodiment of such a robotic welding system 95, as shown for example in FIGS. 2A, 2B, the detecting and tracking means comprises a GPS tracking device and position determining system 300 for firstly tracking a position in 3D space of a datum point DP on the robotic welder. Such datum point can be determined when the robotic welder 100 is stationary by use of such GPS position-determining devices in common use today, and thus due to the known relationship between the datum point DP on the robotic welder 100 and the pointer tip 110A, the relative 3D spatial position of such pointer tip 110A and thus various datapoints along the weld seam 120 when such pointer tip 110A is traced over the weld seam 120 of two components 116, 118 desired to be welded together can be determined, and stored in a memory storage device.

Such pointer tip 110A is in a preferred embodiment a distal end of the torch tip electrode 110 whose relative position relative to the datum point DP is known or can be determined, and such pointer tip 110 is initially controlled by a human operator to trace and follow a location of a desired weld seam 120 of two members 116,118 desired to be welded together to create the series of 3D datapoints of the desired weld seam 120.

Electronic storage means in the form of a memory device 302 is provided to store the created 3D datapoints of the precise location of the weld seam 120 in space.

A controller 130 is provided which is then used to access such stored datapoints and thereafter calculate and provide necessary machine commands to the robotic welder 100 to cause the robotic welder 100 to move the torch tip electrode 110 thereof progressively along a length of weld seam 120 to carry out welding of components 116,118 together.

Accordingly, in order to effect automated welding in this embodiment, in a first step shown in FIG. 2A a pointer tip 110 of robotic welding system 95 is caused by a human operator to closely follow and trace along desired weld seam 120, moving the pointer tip 110A (ie. torch tip electrode 110) in the direction of arrow “ [symbol] ” along desired weld seam 120. GPS coordinates of the pointer tip (torch tip electrode 110) are simultaneously generated as a series of datapoints by controller 130 and such datapoints stored in memory device 302.

After termination of the tracing at the end of weld seam 120, and as a second step and as now shown in FIG. 2B, the robotic welder 100 may then, in absence of human input or oversight, then proceed to use controller 130 to access datapoints stored in memory device 302, and thereafter generate the necessary machine commands to control robot welder arms 102, 104, 106, & 106 so as to then move torch tip electrode 110 in the direction of shown arrow “ [symbol] ” while simultaneously providing electric current to torch tip electrode 110 to create a weld bead 124 along desired weld seam 120 to weld two components 116,118 together.

One may ask where the time saving and advantage of using a robotic welder 100 in this particular embodiment is if a human operator must initially direct the movement of a pointer tip 110A to cause it to trace along a weld seam 120, before the robotic welder 100 can then carry out welding.

The answer is that a non-skilled welder can easily and quickly carry out the tracing of a plethora of weld seam of various components within the range and proximity of robotic arms 102, 104, 106 & 108 of robotic welder 100.

Specifically, the actual welding of weld seams 120 is a substantially slower and more delicate process. the actual welding operation is automated and is subsequently carried out by the robotic welder 100 at any later time, and in absence of human presence, thereby freeing up a human operator to perform other tasks at a construction site or at various locations at a shop or factory facility, resulting in significant time saving and more effective use of workers during normal daylight working hours.

For example, during a day shift at a construction site or within a shop facility or factory floor, a human operator could use a single robotic welder 100 to trace a large number of weld seams 120 at numerous locations on a plurality of articles at discrete locations on a shop floor or at a construction, and a a single moveable robotic welder 100, mounted for example on an overhead moveable gantry within a shop facility and which is moveable in 2 or more dimensions (not shown), or mounted on and transportable by a moveable vehicle as shown in FIG. 4, could be employed for effecting such welding at such discrete locations. Then, after datapoints for the 3D spatial location of all such weld seams 120 has been stored in memory device 302 by the robotic welder, the robotic welder in absence of a human operator such as for example overnight after ending of a shift of a human construction worker, may then perform the welding of all the weld seams 120 by accessing all the 3D datapoints stored in memory device 302 and using controller 130 to operate the servo-motors of the robotic welder 100 to conduct the necessary welding of each of the weld seams 120.

FIGS. 3A, 3B show an alternative second embodiment of a robotic welding system 95, in two separate but similar steps in its operation.

In such embodiment, one or more light detection sensors 112 are mounted proximate the distal arm 108 of robotic welder 100, for sensing the distance that a point source of light, typically a laser source of light (or a reflected point source of light from a light-reflective material 122 (a)) may be from such a sensor 112 or sensors, and are of the type found in LiDaR devices.

The sensor(s) 112 mounted on distal arm 108 are each in a known fixed geometric relationship/configuration to the torch tip electrode 110. Thus the position of the point source of light relative to the torch tip electrode 110 when traced along weld seam 120 is always known.

Thus with reference to FIG. 3A, a human operator may trace a laser point source of light (not shown) along and in close proximity to a well seam 120. Sensor(s) 112 detect such laser point source of light as it is being moved and traced along a weld seam 120.

If only one sensor 112 is used, such sensor may be moved by arm 108 to at least three separate locations (viewpoints) to thereby locate a position in 3D space of the point source of light relative to such sensor 112, and datapoints generated at each location indicating the position in relative 3D space of such sensor (and thus the torch tip electrode 110) relative to such point source of light at each of its separate three locations. This process is continually repeated as the point source of light (eg. a tip of a laser beam) is manually traced over a weld seam 120.

Alternatively, at least three light sensors 112 may be employed, as shown in FIG. 3A, wherein as a point source of light (not shown) is traced along a desired weld seam 120, such as by the manual tracing of a tip of laser beam along weld seam 120, and each of such three sensors 112 simultaneously generate a series of datapoints which are stored, via a controller 130, in an electronic memory storage device 302.

In such manner a location, the location of the weld seam 120 in 3D space relative to the torch tip electrode 110 can be determined.

Thereafter, at an immediately subsequent time or some considerable time thereafter when welding at the traced weld seams 120 is desired to be carried out, controller 130 accesses memory 302 and utilizes the datapoints therein to calculate and provide necessary machine commands to robotic welder 100 and the servo-motors thereon operating robotic arms 102, 104, 106, & 108, to move the torch tip electrode 110 progressively along a length of each weld seam 120 to effect welding of said two members 116,118.

Alternatively, and as similarly shown in FIG. 3A, sensor(s) 112 may similarly be provided for detecting reflections of point sources of light reflecting from a light-reflective paint, ink, or other light-reflective material 122 which is traced over, placed on, or adhered to, a location of the desired weld seam 120.

Again, if only one sensor 112 is used, such sensor may be moved by arm 108 to at least three separate locations (viewpoints) to thereby locate a position in 3D space of the point source of light reflected from light reflective material 122 relative to such sensor 112, and datapoints generated at each location indicating the position in relative 3D space of such sensor (and thus the torch tip electrode 110) relative to such reflected point source of light on reflective material 122 when such sensor is as each of its separate three locations. This process is continually repeated as the point source of light (eg. a tip of a laser beam) is traced over a weld seam 120, and reflected point sources of light are reflected from various locations along weld seam 124.

Alternatively, at least three light sensors 112 may be employed, as shown in FIG. 3A. Distances of various points of reflected light, such as reflected when laser light, infra-red light, or ultraviolet light illuminates a reflective material 122 which is placed over and along weld seam 120, from each of the three sensors 112 are simultaneously recorded in a series of datapoints which are generated over a series of points along reflective material 122 placed along weld seam 120.

As in the preceding embodiment, at an immediately subsequent time or some considerable time thereafter when welding at the traced weld seams 120 is desired to be carried out, controller 130 accesses memory 302 and utilizes the stored datapoints so as to calculate and provide necessary machine commands to robotic welder 100 and the servo-motors thereon operating robotic arms 102, 104, 106, & 108, to move the torch tip electrode 110 progressively along a length of each weld seam 120 to effect welding of said two members 116,118.

In a further alternative embodiment and as perhaps best seen from FIG. 3A, the detecting and tracking means may comprise at least three ccd camera and associated distance measuring device 112 (such as a laser range finder), which is programmed and configured to track and sense the distance therefrom that a tip of a pointer object (which pointer object and tip thereof could be a torch tip electrode 110 or alternatively and independent pointer object) as the tip of the pointer object is traced along, by human direction, a desired weld seam 120. The distance measuring device for each of the three sensors 112 is further adapted to give, distances from each sensor to the pointer tip, and thus a series of datapoints generated as the pointer object is traced along the weld seam 120.

Thereafter, as in the previous embodiments, at an immediately subsequent time or some considerable time thereafter when welding at the traced weld seams 120 is desired to be carried out, controller 130 accesses memory 302 and utilizes the datapoints so as to calculate and provide necessary machine commands to robotic welder 100 and the servo-motors thereon operating robotic arms 102, 104, 106, & 108, to move the torch tip electrode 110 progressively along a length of each weld seam 120 to effect welding of said two members 116,118.

In a refinement of the invention, if a robotic welder 100 of the present invention is moved from location to location at a construction site, at each location the thicknesses and materials 116, 118 being welded may be different, requiring adjustment to the speed of travel of the torch tip electrode 110 along a traced path 122, and/or adjustment of the amount of amperage of electrical current applied to the torch tip electrode 110 to thereby adjusted the height and depth of the created a weld bead 124, so it is of a desired thickness and penetration for optimum welding.

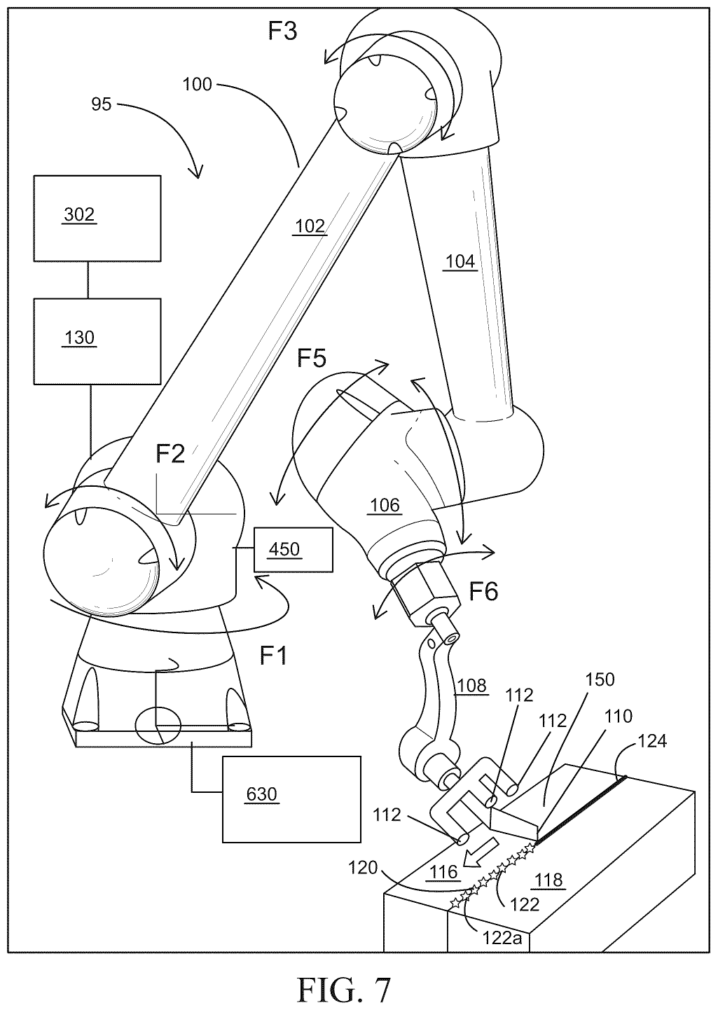

Accordingly, in such further embodiment, as in FIG. 7, during the welding process, sensors 150 may further be provided, or sensors 112 provided with the further capability, during the welding step, to sense the height and/or depth of a created weld bead 124. In such embodiment, the sensing of the height or depth of the weld bead may be determined in any number of ways, such as by a heat-resistant mechanical sensor 150 which senses height and/or depth of the created weld bead 124. Other means, either electronic, electrical resistive, or mechanical, of determining the height or depth of the created weld bead 124 will now occur to persons of skill in the art.

In a preferred embodiment, and as seen in FIG. 7, automated means 450 may be provided, in response to input from the sensor 150 as to whether the weld bead 124 depth or weld bead height is within desired tolerances, to allow robotic welding system 100 to automatically adjust the speed of travel of said torch tip electrode 110 along traced path 122. Alternatively, such means 450 may allow robotic welding system 100 to automatically adjust the speed of travel of said torch tip electrode 110 along traced path 122. Alternatively, such means 450 may be manual means, as commonly provided on manual welding devices, to allow a human operator to adjust such parameters.

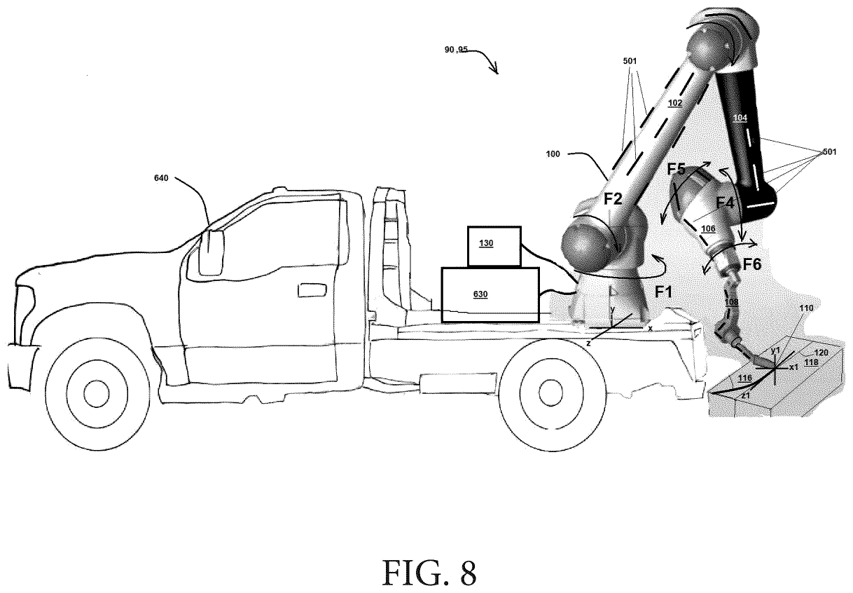

In a further preferred embodiment/refinement of the robotic welding system 100 of the present invention, and as shown for example in FIG. 8, obstruction detection means which may be in the form of a plurality of sonar-emitting devices 501 placed along and attached to a number of surfaces of each of robotic arms 102, 104, 106, and 108, may be provided.

Alternatively, such obstruction detection means may be a LidaR laser scanning systems (not shown) mounted on the welding system 100 and which creates a 3D digital point cloud of the immediate environment in which the robotic welder 100 and its arms 102,104, 106, and 108 can extend, and provides such digital point cloud scan of the environment to the controller 130.

In the event that machine commands generated by controller 130 during a welding operation would cause a robotic arm or arms 102, 104, 106, or 108 of robotic welding system 100 w to contact and thus be constrained in their movement by proximate objects or obstacles as sensed by such sonar-emitting devices 501 or as indicated from such generated 3D digital point cloud, the controller 130 is further adapted to cease continued movement of the robotic arms 102, 104, 106, and/or 108 along a previously pre-determined path, and to then generate alternative machine commands to cause said robotic arm or arms 102, 104, 106, and/or 108 to move in an alternate path when welding which avoid contact with said obstruction and permit said torch electrode tip to follow said traced path.

As where there is a number of degrees of freedom to the motion of the robotic welder arms 102,104, 106, 108 (such as six degrees of freedom for the robotic welding system shown in FIGS. 1, 2A, 2B, 3A, 3B, 4, 7 & 8, there will typically be an number of alternative paths of motion which would allow the controller to provide machine commands to one or more of robotic arms 102,104, 106, 108 to avoid such obstacles. In accordance with this aspect of the present invention, the controller 130 of robotic welder 100 may be further programmed to continually randomly attempt various motion solutions and machine commands regarding the motions of one or more of its arms 102, 104, 106, 108, and to determine in each case if such provides an obstacle-free path (i.e. a “motions solution”), and to continue such attempts until an obstacle-free path of motion of its arms 102, 104, 106, 108 is obtained to allow continued welding of a traced path 122 whose position is known in 3D space.

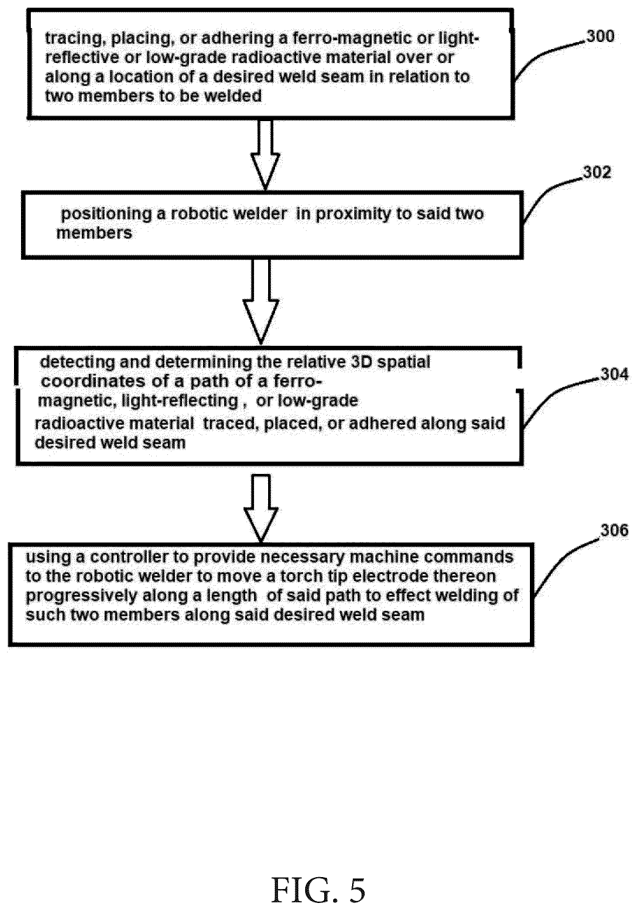

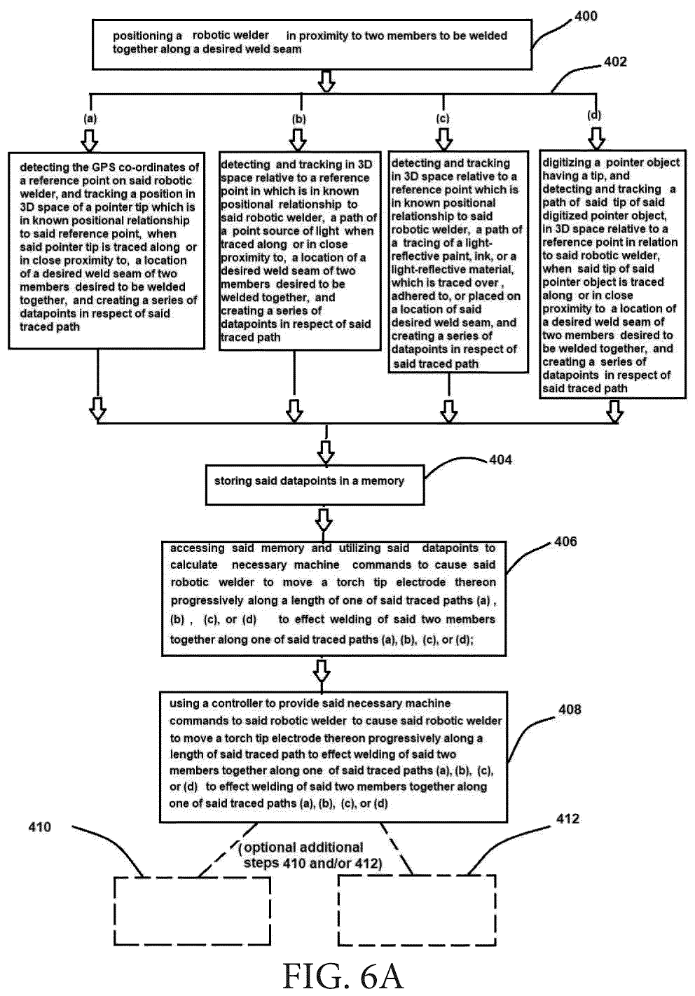

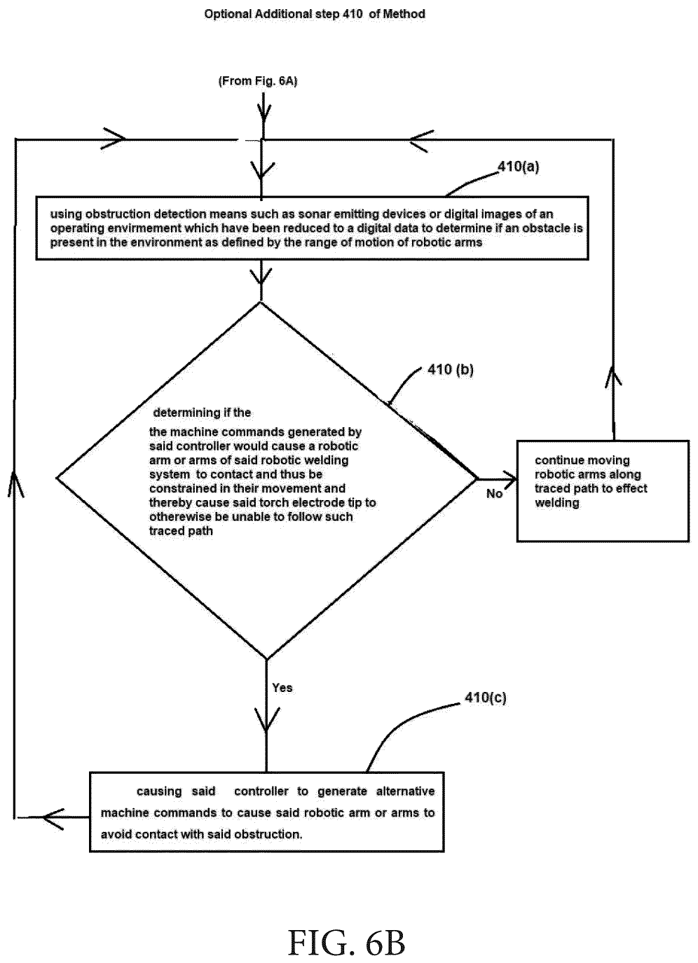

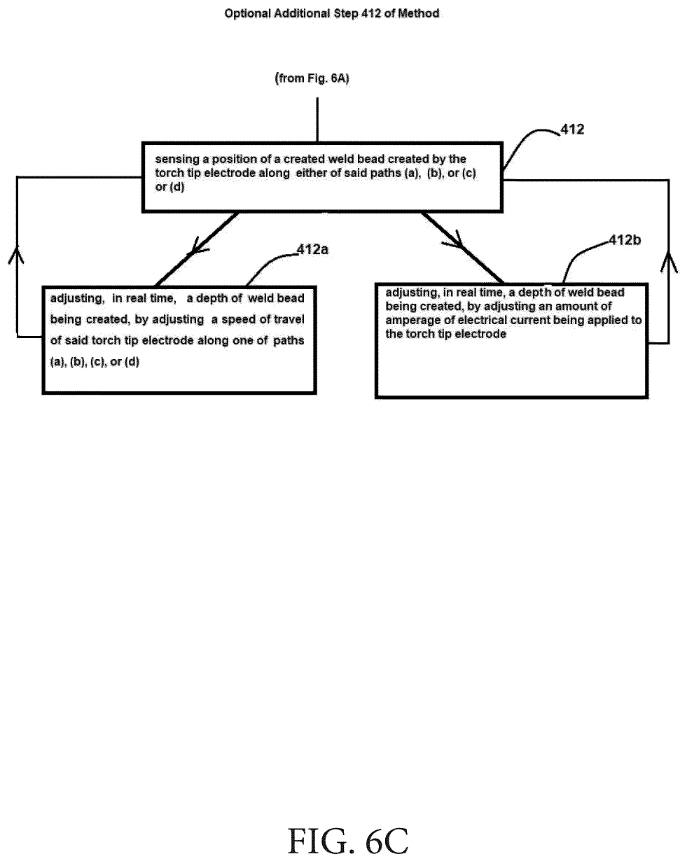

FIGS. 5 & FIG. 6A schematically depict two distinct methods of operating a robotic welding system of the present invention.

In the method shown in FIG. 5, initial step 300 comprises the tracing, placing, or adhering of a ferro-magnetic or light reflective or low-grade radioactive material 122a over or along a location of a desired weld seam 120 in relation to two members 116, 118, to be welded.

Subsequent step 302 in such method comprises positioning a robotic welder

Subsequent step 304 in such method comprises detecting and determining relative 3D coordinates of a path of the ferro-magnetic light-reflecting, or low-grade radioactive material 122a which is traced, placed, or adhered along a desired weld seam 120.

Subsequent step 306 in such method comprises using a controller 130 to provide necessary machine commands to servo-motors on the robotic welder which control its respective arms 102, 104, 106 & 108 to move a torch tip welding electrode thereon progressively along a length of a traced path 122 to effect welding of two members 116, 118 along the desired weld seam 120.

FIG. 6A depicts, in steps 400, 402, 404, 406 and 408 thereof various steps of an alternative method as described earlier herein.

The method of FIG. 6A, as may be seen, provides for two separate and additional optional refinements, namely step 410, which is more fully depicted in FIG. 6B, and step 412, which is more fully depicted in FIG. 6C.

Specifically, as regards optional step 410 as more fully depicted in FIG. 6B, in step 410 (a) the initial step of using obstruction detection means, such as sonar-emitting devices 501 or digital images of an operating environment as reduced to a digital datapoint set, to determine if an obstacle is present in the environment defined by the range of motion of the robotic arms.

Step 410 (b) comprises the step of determining if the machine commands generated by the controller 130 would cause a robotic arm or arms 102,104,106, and/or 108 to contact and thus be constrained in their movement and thereby cause torch electrode tip 110 to be otherwise unable to follow the traced path 122. If the answer is “no”, the controller 130 continues to direct robotic arms 102,104, 106, & 108 to direct torch tip electrode 110 to continue welding along traced path 122. If the answer is “yes”, step 401 (c) provides that the controller 130 is caused to generate alternative machine commands to cause the robotic arm or arms 102,104, 106, & 108 to avoid contact with the obstruction. The steps 410 (a) and 401 (b) are further and continuously repeated at all times when the controller 130 is providing or about to provide machine commands to the servo-motors which control movement of robotic arms 102, 104, 106, & 108.

FIG. 6C depicts optional step 412 in FIG. 6A in greater detail, and relates to the optional step of allowing for automated or manual adjustment of the speed of travel of the torch tip electrode along the weld seam 120 and/or the amount of electrical current applied to torch tip electrode 110 as a means of adjusting the height or depth of penetration of weld bead 124 being created along weld seam 120.

Such optional additional step 412 may comprise, as shown in FIG. 6C the step of sensing a height or depth of a weld bead 124 created by the torch tip electrode 110. Thereafter, such method allows for the alternative or combined steps 412a and 412b of adjusting, in step 412 (a), a speed of travel of torch tip electrode along a traced path 122 along a weld seam 120 and/or in step 412 (b) adjusting an amount of amperage being applied to torch tip electrode 110 during welding, to thereby adjust the height and/or depth of penetration of weld bead 124.

The foregoing description of the disclosed embodiments of the system and methods of the present invention are provided to enable any person skilled in the art to make or use the present invention. The scope of the claims should not be limited by the preferred embodiments set forth in the examples, but should be given the broadest interpretation consistent with the specification, including the description and drawings, as a whole. Thus, the present invention is not intended to be limited to the embodiments shown herein, but is to be accorded the full scope consistent with the claims.

For a complete definition of the invention and its intended scope, reference is to be made to the summary of the invention and the appended claims read together with and considered with the disclosure and drawings herein.

We claim:

1. A robotic welding system, comprising:
(i) a robotic welder, having a torch tip electrode for conducting or providing a source of electric current and which torch tip electrode is variably positionable and moveable in three or more degrees of freedom;
(ii) detecting means:
(a) for detecting a path of a previously-created manual tracing of a ferro-magnetic, light-reflective, or low-grade radioactive material, which is traced over, adhered to, or placed on or along a location of said desired weld seam in relation to one or more articles on which welding is required along said desired weld seam thereon;
and
(iii) a controller for receiving input from said detecting means and providing necessary machine commands to said robotic welder to cause said robotic welder to commence welding at one end of said manual tracing and to progressively move said torch tip electrode thereof along a length of said manual tracing to thereby effect welding along said desired weld seam on said one or more articles.

2. A robotic welding system, comprising:
(i) a robotic welder, having a torch tip electrode for providing an electric current and which torch tip electrode is variably positionable and moveable in three or more degrees of freedom;
(ii) detecting and tracking means:
(a) for detecting the GPS spatial co-ordinates of a reference point on said robotic welder when stationary, and tracking a position in 3D space of a pointer tip which is in constant known positional relationship to said reference point when said pointer tip is traced along a location of a desired weld seam of two members desired to be welded together, and creating a series of datapoints of known GPS co-ordinates in respect of said traced path; or
(b) for detecting and tracking position in 3D space relative to a reference point in which is in known positional relationship to said robotic welder, a path of a point source of light when traced along a location of a desired weld seam of two members desired to be welded together, and creating a series of datapoints in respect of said traced path; or
(c) for detecting and tracking in 3D space relative to a reference point which is in known positional relationship to said robotic welder, a path of a tracing of a light-reflective paint, ink, or a light-reflective material, which is traced over or placed on or adhered to a location of said desired weld seam, and creating a series of datapoints in respect of said traced path; or
(d) for digitizing a pointer object having a tip, and detecting and tracking a path of said tip of said digitized pointer object, in 3D space relative to a reference point in relation to said robotic welder, when said tip of said pointer object is traced along a desired weld seam of two members desired to be welded together, and creating a series of datapoints in respect of said traced path;
(iii) storage means for storing of said datapoints in a memory; and
(iv) a controller for accessing said memory and utilizing said datapoints so as to calculate and provide necessary machine commands to said robotic welder to cause said robotic welder to move said torch tip electrode thereof progressively along a length of either of said traced paths (a), (b), (c), or (d) to effect welding of said two members together along one of said traced paths (a), (b), (c), or (d).

3. The robotic welding system as claimed in claim 2 (ii) (a) or claim 2 (ii) (d), wherein said pointer tip or said tip of said pointer object is a distal end of a torch tip electrode mounted at an extremity of a robotic arm of the robotic welder.

4. The robotic welding system as claimed in claim 2, wherein:
said detecting and tracking means in (ii) (b), (c), or (d) comprises at least three detecting and tracking means on said robotic welder for together tracking of said path by each simultaneously measuring or determining distances of numerous points in said traced path in (b), (c), or (d) from each of said at least 3 detecting and tracking means; and
said at least three detecting and tracking means, along with computing means, adapted to determine the location in 3D space of said numerous points on said traced path by triangulation of each of said numerous datapoints obtained from each of said at least three detecting and tracking means.

5. The robotic welding system as claimed in claim 4, wherein:
each of said at least 3 detection and tracking means comprises:
a camera or charge coupled device (CCD) to detect light reflected from said traced path,
a laser light source and means for directing said laser light source along or on said detected traced path; or
means for determining distance of each of said numerous points on said traced path from said reference point using said laser light source and
light detection and ranging (LIDAR).

6. The robotic welding system as claimed in any one of preceding claim 1 or 2, wherein:
said robotic welding system is portable; and
said robotic welding system is further provided with stabilization means for stabilizing said robotic welding system at a location where said two or more members desired to be welded.

7. The robotic welding system as claimed in claim 1 or 2 further comprising:
a sensor means for sensing a height or depth of weld bead created by said torch tip electrode along one of paths (ii) (a), (b), or (c) or (d); and
means for controlling, in real time, one or more of:
(i) a speed of travel of said torch tip electrode along said path; or
(ii) an amount of amperage of electrical current applied to said torch tip electrode.

8. The robotic welding system as claimed in any one of preceding claim 1 or 2, further comprising:
operator input means to allow an operator to set and/or adjust a position of a weld bead being created by adjusting tracking of said torch electrode tip on the robotic arm along the traced or determined path in real time.

9. The robotic welding system as claimed in claim 1, further comprising:
obstruction detection means which detects proximity of or 3D spatial location of any possible obstruction if the machine commands generated by said controller would cause a robotic arm or arms of said robotic welding system or portions thereof to contact and thus be constrained in their movement and which would otherwise cause said torch electrode tip to be unable to follow such traced path; and
in the event a possible obstruction being indicated, said controller is adapted to generate alternative machine commands to cause said robotic arm or arms to avoid contact with said obstruction and permit said torch electrode tip to follow said traced path.

10. The robotic welding system as claimed in claim 2, further comprising:
obstruction detection means which detects 3D spatial location of any possible obstruction if the machine commands generated by said controller would cause a robotic arm or arms of said robotic welding system or portions thereof to contact and thus be constrained in their movement and which would otherwise cause said torch electrode tip to be unable to follow such traced path; and
in the event a possible obstruction is indicated, said controller is adapted to generate alternative machine commands to cause said robotic arm or arms to avoid contact with said obstruction and so as to permit said torch electrode tip to follow said traced path.

11. The robotic welding system as claimed in claim 9 or 10, wherein said obstruction detection means comprises one of the obstruction detection devices selected from the group of obstruction detection devices comprising laser light emitting devices and sonar emitting devices.

12. A method for operating a robotic welding apparatus, comprising the steps of:
i) positioning a robotic welder in proximity to two members to be welded together along a desired weld seam;
(ii) detecting a path of a ferro-magnetic, light reflective, or low-grade radioactive material which is traced over or placed along or adhered to a location of said desired weld seam, and creating a series of datapoints in respect of a detected location in 3D space of said traced path; and
(iii) using a controller to provide said necessary machine commands to said robotic welder to cause said robotic welder to move a torch tip electrode thereon progressively along a length of said tracing path to effect welding of said two members together along said desired weld seam.

13. The method as claimed in claim 12, further including a step prior to step (iii) of creating a series of datapoints in respect of a 3D spatial location of said path relative to a location of a reference datum point of said robotic welder.

14. The method as claimed in claim 13, further comprising the steps of:
moving a flexible tracing tool, having a known physical relationship in reference to a datum point on said robotic welder, over and along said traced path and recording or storing the spatial 3D position of said tracing tool as it is moved along said traced path so as to create said series of datapoints; and
thereafter using the series of datapoints and said controller to provide said necessary machine commands to the robotic welder to cause the robotic welder to move the torch tip electrode thereon progressively along the length of the tracing path and at the same time effect welding along the desired weld seam.

15. The method as claimed in claim 14, wherein said flexible tracing tool is said torch tip electrode of the robotic welder, when in a non-energized and non-welding state.

16. A method for operating a robotic welding apparatus, comprising the steps of:
(i) positioning a robotic welder in proximity to two members to be welded together along a desired weld seam;
(ii) carrying out the step of either:
(a) detecting the GPS co-ordinates of a reference point on said robotic welder, and tracking a position in 3D space of a pointer tip which is in known positional relationship to said reference point, when said pointer tip is traced along or in close proximity to, a location of a desired weld seam of two members desired to be welded together, and creating a series of datapoints in respect of said traced path; or
(b) detecting and tracking in 3D space relative to a reference point in which is in known positional relationship to said robotic welder, a path of a point source of light when traced along or in close proximity to, a location of a desired weld seam of two members desired to be welded together, and creating a series of datapoints in respect of said traced path; or
(c) detecting and tracking in 3D space relative to a reference point which is in known positional relationship to said robotic welder, a path of a tracing of a light-reflective paint, ink, or a light-reflective material, which is traced over, adhered to, or placed on a location of said desired weld seam, and creating a series of datapoints in respect of said traced path; or
(d) digitizing a pointer object having a tip, and detecting and tracking a path of said tip of said digitized pointer object, in 3D space relative to a reference point in relation to said robotic welder, when said tip of said pointer object is traced along or in close proximity to a location of a desired weld seam of two members desired to be welded together, and creating a series of datapoints in respect of said traced path;
(iii) storing said datapoints in a memory; and
(iv) accessing said memory and utilizing said datapoints to calculate necessary machine commands to cause said robotic welder to move a torch tip electrode thereon progressively along a length of one of said traced paths (a), (b), (c), or (d) to effect welding of said two members together along one of said traced paths (a), (b), (c), or (d); and
(vii) using a controller to provide said necessary machine commands to said robotic welder to cause said robotic welder to move a torch tip electrode thereon progressively along a length of said traced path to effect welding of said two members together along one of said traced paths (a), (b), (c), or (d) to effect welding of said two members together along one of said traced paths (a), (b), (c), or (d).

17. The method for operating a robotic welding apparatus as claimed in one of steps (b), (c) or (d) of claim 16, wherein:
said step of detecting and tracking comprises utilizing at least three detecting and tracking means which track said traced path by each simultaneously measuring or determining distances of numerous points in said traced path in (b), (c), or (d) from said reference point; and
utilizing triangulation of each of said numerous points of obtained from each of said at least three detecting and tracking means to determine the location in 3D space of said numerous points on said traced path.

18. The method for operating a robotic welding apparatus as claimed in any one of claims 12-17, further comprising the step of:
detecting any possible obstruction if the machine commands generated by said controller would cause a robotic arm or arms of said robotic welding system to contact and thus be constrained in their movement and thereby cause said torch electrode tip to otherwise be unable to follow such traced path; and
in the event a possible obstruction is indicated, causing said controller to generate alternative machine commands to cause said robotic arm or arms to avoid contact with said obstruction.

19. The method for operating a robotic welding apparatus as claimed in one of steps (a) (b), (c) or (d) of claim 16, further comprising the steps of:
sensing a position of a created weld bead created by said torch tip electrode along either of said paths (a), (b), or (c) or (d); and
adjusting, in real time, a depth of weld bead being created, by adjusting one or more of:
(i) a speed of travel of said torch tip electrode along said paths; or
(iii) an amount of amperage of electrical current applied to said torch tip electrode.

20. The robotic welding system as claimed in claim 1 or 2, wherein system robotic welding system is transportable, such as by:
(i) mounting on an overhead moveable gantry which is moveable in 2 or more dimensions within a shop facility, to allow said torch tip electrode thereof to be brought in proximity to one or more articles having a desired weld seam thereon; or
(ii) by mounting on a vehicle, for transportation to various locations where articles or objects variously situated abot a construction site.
